(19) United States
(12) Patent Application Publication
(10) Pub. No.: US 2026/0321288 A1
(43) Pub. Date: Oct. 15, 2026

(54) DATA STORAGE DEVICE WITH OPTIMIZED WRITE PERFORMANCE FOR AN UNEQUAL NUMBER OF READERS AND WRITERS

(71) Applicant: WESTERN DIGITAL TECHNOLOGIES, INC., San Jose, CA (US)

(72) Inventors: David R. Hall, Rochester, MN (US); Ali Khalili, Minneapolis, MN (US); Andrew Larson, Rochester, MN (US); Shad H. Thorstenson, Rochester, MN (US)

(21) Appl. No.: 19/179,389

(22) Filed: Apr. 15, 2025

(51) Int. Cl. G11B 20/12

(52) U.S. Cl. CPC G11B 20/1217; G11B 2020/1238

(57) ABSTRACT

Various illustrative aspects are directed to a data storage device, method, and one or more processing devices that are configured to: divide data associated with a write command into multiple data chunks; write respective ones of the multiple data chunks to at least two tracks among the plurality of tracks at locations associated with sequential logical block addresses (LBAs), wherein respective ones of the locations associated with the sequential LBAs alternate between the at least two tracks; and in response to a read command associated with the data, read the multiple data chunks from the at least two tracks by passing read elements simultaneously over the at least two tracks.

### BACKGROUND

Data storage devices such as disk drives comprise a disk and a head connected to a distal end of an actuator arm, which is rotated about a pivot by a voice coil motor (VCM) to position the head radially over the disk. The disk comprises a plurality of radially spaced, concentric tracks for recording user data sectors and servo wedges or servo sectors. The servo sectors comprise head positioning information (e.g., a track address), which is read by the head and processed by a servo control system to control the actuator arm as it seeks from track to track.

FIG. 1 shows a prior art disk format 2 as comprising a number of radially-spaced, concentric servo tracks 4 defined by servo wedges 6₀-6_{N} recorded around the circumference of each servo track. A plurality of concentric data tracks is defined relative to the servo tracks 4, wherein the data tracks may have the same or a different radial density (e.g., tracks per inch (TPI)) than the servo tracks 4. Each servo wedge 6ᵢ comprises a preamble 8 for storing a periodic pattern, which enables proper gain adjustment and timing synchronization of the read signal, and a sync mark 10 for storing a special pattern used to symbol synchronize to a servo data field 12. The servo data field 12 stores coarse head positioning information, such as a servo track address, used to position the head over a target data track during a seek operation. Each servo wedge (e.g., servo wedge 6₄) further comprises groups of phase-based servo bursts 14 (e.g., N and Q servo bursts), which are recorded with a predetermined phase relative to one another and relative to the servo track centerlines.

The coarse head position information is processed to position a head over a target data track during a seek operation, and the servo bursts 14 provide fine head position information used for centerline tracking while accessing a data track during write/read operations. A position error signal (PES) is generated by reading the servo bursts 14, wherein the PES represents a measured position of the head relative to a centerline of a target servo track. A servo controller processes the PES to generate a control signal applied to one or more head actuators in order to actuate the head radially over the disk in a direction that reduces the PES. The one or more head actuators may comprise a voice coil motor, as well as one or more fine control actuators such as milliactuators or microactuators, in some examples.

### SUMMARY

Various examples disclosed herein provide data storage devices such as hard disk drives with control circuitry configured to perform novel and inventive methods for writing data to multiple tracks in a multi-access disk drive. In various examples, control circuitry of this disclosure is inventively configured to map sequential logical block addresses (LBAs) to locations that alternate between two or more tracks in a down-track direction. In this manner, implementations enable optimizing write performance in disk drives having an unequal number of readers and writers.

Disk drives may be configured to read data from multiple tracks of one or more disk surfaces simultaneously using multiple read elements to achieve an increased read data rate compared to disk drives that read data from only a single track at a time using a single read element. Disk drives that use multiple read elements to simultaneously read data from multiple tracks may be referred to as multi-access disk drives. Some multi-access disk drives include an unequal number of readers and writers in a head (or slider), such as one writer and two readers in the same head. During a write operation, these disk drives utilize the one writer to write first a portion of the data to a first track during a first revolution of the disk and then write a second portion of the data to a second track during a second revolution of the disk. During a read operation, these disk drives utilize the two readers in the same head to concurrently read the first portion of the data from the first track and the second portion of the data from the second track. Using two readers to concurrently read the data from the two tracks enables higher read data rates compared to conventional disk drives that read data from only a single track at a time using a single reader. However, these disk drives have poor write performance because they require two revolutions of the disk when writing the data to the respective ones of the two tracks.

Embodiments according to the present disclosure address this problem of poor write performance in multi-access disk drives that include an unequal number of readers and writers by providing a strategy for writing data that maximizes read gain and minimizes write loss. Disk drives in accordance with aspects of the present disclosure may comprise an unequal number of readers and writers in a head and may be configured to write data associated with a write command to paired tracks of a disk surface during a single revolution of the disk by alternating writing chunks of the data between the paired tracks during the single revolution of the disk. Disk drives in accordance with aspects of the present disclosure may read the chunks from the paired tracks by passing multiple readers simultaneously over the paired tracks in response to a read command associated with the data. By reading data using multiple readers that pass over the paired tracks simultaneously, disk drives according to the present disclosure enable higher read data rates compared to conventional disk drives that read data from only a single track at a time using a single reader. Moreover, by writing data to the paired tracks in a single revolution of the disk, disk drives according to the present disclosure enable higher write data rates compared to multi-access disk drives that write data to paired tracks in two successive revolutions of the disk. In this manner, disk drives according to the present disclosure provide an improved total data rate for multi-access disk drives by greatly improving the write data rate associated with writing data while also enabling the high read data rate achieved by reading multiple tracks simultaneously.

Various illustrative aspects are directed to a data storage device comprising a disk having a disk surface that includes a plurality of tracks, a head configured to be positioned proximate to the disk surface and including N number of read elements and M number of write elements, wherein N is greater than M, and one or more processing devices, individually or in combination, configured to: divide data associated with a write command into multiple data chunks; write respective ones of the multiple data chunks to at least two tracks among the plurality of tracks at locations associated with sequential logical block addresses (LBAs), wherein respective ones of the locations associated with the sequential LBAs alternate between the at least two tracks; and in response to a read command associated with the data, read the multiple data chunks from the at least two tracks by passing the read elements simultaneously over the at least two tracks.

Various illustrative aspects are directed to a method comprising: dividing data associated with a write command into multiple data chunks; writing respective ones of the multiple data chunks to at least two tracks among a plurality of tracks at locations associated with sequential logical block addresses (LBAs), wherein the plurality of tracks are on a disk surface associated with a disk in a disk drive, and wherein respective ones of the locations associated with the sequential LBAs alternate between the at least two tracks; and in response to a read command associated with the data, reading the multiple data chunks from the at least two tracks by passing read elements simultaneously over the at least two tracks.

Various illustrative aspects are directed to one or more processing devices comprising: means for dividing data associated with a write command into multiple data chunks; means for writing respective ones of the multiple data chunks to at least two tracks among a plurality of tracks at locations associated with sequential logical block addresses (LBAs), wherein the plurality of tracks are on a disk surface associated with a disk in a disk drive, and wherein respective ones of the locations associated with the sequential LBAs alternate between the at least two tracks; and means for reading the multiple data chunks from the at least two tracks by passing read elements simultaneously over the at least two tracks in response to a read command associated with the data.

Various further aspects are depicted in the accompanying figures and described below and will be further apparent based thereon.

### BRIEF DESCRIPTION OF THE DRAWINGS

Various features and advantages of the technology of the present disclosure will be apparent from the following description of particular examples of those technologies and as illustrated in the accompanying drawings. The drawings are not necessarily to scale. The emphasis instead is placed on illustrating the principles of the technological concepts. In the drawings, like reference characters may refer to the same parts throughout the different views. The drawings depict only illustrative examples of the present disclosure and are not limiting in scope.

FIG. 1 shows a prior art disk format comprising a number of radially-spaced, concentric servo tracks defined by servo wedges recorded around the circumference of each servo track.

FIGS. 2A and 2B illustrate conceptual block diagrams of a top view and a side view of a data storage device in the form of a disk drive, in accordance with aspects of the present disclosure.

FIG. 2C depicts a flowchart for an example method that control circuitry of a disk drive may perform or execute in controlling the operations of the disk drive, in accordance with aspects of the present disclosure.

FIG. 3 illustrates a conceptual block diagram of a top view of a head relative to a disk in a multi-access disk drive in accordance with various aspects of the present disclosure.

FIG. 4 illustrates a conceptual block diagram of a mapping of portions of tracks on a disk surface to logical block addresses (LBAs) in accordance with various aspects of the present disclosure.

FIG. 5 illustrates a conceptual block diagram of writing data chunks to sequential LBAs in an alternating manner between paired tracks in a multi-access disk drive in accordance with various aspects of the present disclosure.

FIG. 6 illustrates a conceptual block diagram of data chunks associated with different write commands written to paired tracks in an alternating and interleaved manner in a multi-access disk drive in accordance with various aspects of the present disclosure.

FIG. 7 illustrates a conceptual block diagram of data chunks associated with different write commands written to paired tracks in an alternating and interleaved manner in a multi-access disk drive in accordance with various aspects of the present disclosure.

FIG. 8 illustrates a conceptual block diagram of data chunks associated with different write commands written to paired tracks in an alternating and interleaved manner in a multi-access disk drive in accordance with various aspects of the present disclosure.

FIG. 9 illustrates a conceptual block diagram of writing data chunks associated with a large write command to sequential LBAs in an alternating manner between paired tracks in a multi-access disk drive in accordance with various aspects of the present disclosure.

### DETAILED DESCRIPTION

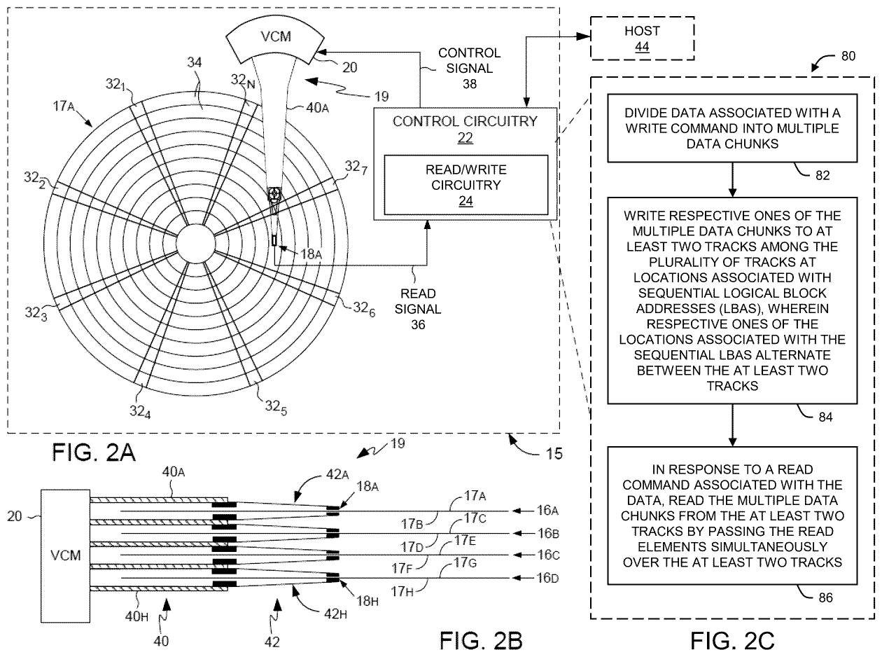

FIGS. 2A and 2B illustrate conceptual block diagrams of a top view and a side view of a data storage device in the form of a disk drive 15, in accordance with aspects of the present disclosure. Disk drive 15 comprises control circuitry 22, an actuator arm assembly 19, and a plurality of hard disks 16A, 16B, 16C, 16D (“hard disks 16”). FIG. 2C depicts a flowchart for an example method 80 that read/write circuitry 24 of control circuitry 22 may perform or execute in controlling the operations of disk drive 15, including optimizing write performance in disk drives having an unequal number of readers and writers in accordance with aspects of the present disclosure.

Actuator arm assembly 19 comprises a primary actuator 20 (e.g., a voice coil motor (VCM)) and a number of actuator arms 40 (e.g., topmost actuator arm 40A, as seen in the top and side views of FIGS. 2A and 2B). Each of actuator arms 40 comprises a suspension assembly 42 at a distal end thereof (e.g., topmost suspension assembly 42A comprised in topmost actuator arm 40A, in the view of FIGS. 2A and 2B). Each suspension assembly 42 may comprise one or more additional fine actuators, in some examples.

Each of actuator arms 40 is configured to suspend a read/write head 18 in close proximity over a corresponding disk surface 17 (e.g., read/write head 18A suspended by topmost actuator arm 40A over topmost corresponding disk surface 17A and read/write head 18H suspended by lowest actuator arm 40H over lowest corresponding disk surface 17H). Other examples may include any of a wide variety of other numbers of hard disks and disk surfaces, and other numbers of actuator arm assemblies, primary actuators, and fine actuators besides the one actuator arm assembly 19 and the one actuator in the form of primary actuator 20 in the example of FIGS. 2A and 2B, for example.

In various examples, disk drive 15 may be considered to perform or execute functions, tasks, processes, methods, and/or techniques, including aspects of example method 80, in terms of its control circuitry 22 performing or executing such functions, tasks, processes, methods, and/or techniques. Control circuitry 22 may comprise and/or take the form of one or more driver devices and/or one or more other processing devices of any type, and may implement or perform functions, tasks, processes, methods, or techniques by executing computer-readable instructions of software code or firmware code, on hardware structure configured for executing such software code or firmware code, in various examples. Control circuitry 22 may also implement or perform functions, tasks, processes, methods, or techniques by its hardware circuitry implementing or performing such functions, tasks, processes, methods, or techniques by the hardware structure in itself, without any operation of software, in various examples. Control circuitry 22 may be operatively in communicative and/or control connection or coupling with a host 44, which may include any external processing, computing, and/or data management entity, such as a computing device, a storage area network, a data center, a cloud computing resource of any kind, and/or any other kind of host, in various examples.

Control circuitry 22 may comprise one or more processing devices that constitute device drivers, specially configured for driving and operating certain devices, and one or more modules. Such device drivers may comprise one or more head drivers, configured for driving and operating heads 18. Device drivers may be configured as one or more integrated components of one or more larger-scale circuits, such as one or more power large-scale integrated circuit (PLSI) chips or circuits, and/or as part of control circuitry 22, in various examples. Device drivers may also be configured as one or more components in other large-scale integrated circuits such as system on chip (SoC) circuits, or as more or less stand-alone circuits, which may be operably coupled to other components of control circuitry 22, in various examples.

Primary actuator 20 may perform primary, macroscopic actuation of a plurality of actuator arms 40, each of which may suspend one of heads 18 over and proximate to corresponding disk surfaces 17 of disks 16. The positions of heads 18 (e.g., heads 18A and 18H) are indicated in FIG. 2A, although heads 18 are generally positioned very close to the disk surfaces and are too small to be visible if depicted to scale in FIGS. 2A and 2B.

Example disk drive 15 of FIGS. 2A and 2B comprises four hard disks 16. Other examples may comprise any number of disks, such as just one disk, two disks, three disks, or five or more disks, or ten or eleven or more disks. Hard disks 16 may also be known as platters, and their disk surfaces may also be referred to as media, or media surfaces. The four hard disks 16 comprise eight disk surfaces 17A, 17B, 17C, 17D, 17E, 17F, 17G, and 17H (“disk surfaces 17”), with one disk surface 17 on each side of each hard disk 16, in this illustrative example. Actuator assembly 19 suspends heads 18 of each actuator arm 40 over and proximate to a corresponding disk surface 17, enabling each of heads 18 to write control features and data to, and read control features and data from, its respective, proximate disk surface 17. In this sense, each head 18 of each actuator arm 40 interacts with a corresponding disk surface 17. As used herein, a head 18 may be said to operate “over” a corresponding disk surface 17 in terms that define the local frame of reference in accordance therewith.

The term “disk surface” may be understood to have the ordinary meaning it has to persons skilled in the applicable engineering fields of art. The term “disk surface” may be understood to comprise both the very outer surface layer of a disk as well as a volume of disk matter beneath the outer surface layer, which may be considered in terms of atomic depth, or (in a simplified model) the number of atoms deep from the surface layer of atoms in which the matter is susceptible of physically interacting with the heads. The term “disk surface” may comprise the portion of matter of the disk that is susceptible of interacting with a read/write head in disk drive operations, such as control write operations, control read operations, data write operations, and data read operations, for example.

In the embodiment of FIGS. 2A and 2B, each disk surface (e.g., disk surface 17A as shown in FIG. 2A) comprises a plurality of control features. The control features comprise servo wedges 32₁-32_{N}, which define a plurality of servo tracks 34, wherein data tracks are defined relative to the servo tracks 34, and which may be at the same or different radial density. Control circuitry 22 processes a read signal 36 emanating from the respective head, e.g., head 18A, to read from disk surface 17A, to demodulate the servo wedges 32₁-32_{N} and generate a position error signal (PES) representing an error between the actual position of the head and a target position relative to a target track. A servo control system in the control circuitry 22 filters the PES from the servo wedges using a suitable compensation filter to generate a control signal 38 applied to actuator arm assembly 19, including to control actuator 20, which functions as a primary actuator, and which rotates actuator arm assembly 19 about an axial pivot in order to perform primary actuation of the corresponding heads 18 radially over the disk surfaces 17 in a direction that reduces the PES, as well as to control any fine actuators, in various examples. Control circuitry 22 may also apply control signals to and receive sensor signals from heads 18 and/or any of various components of disk drive 15, in various examples.

In the example of FIGS. 2A and 2B, actuator arm assembly 19 rotates actuator arms 40 about a common pivot. In another example, a first actuator arm assembly and/or VCM and a second actuator arm assembly and/or VCM, or other types of primary actuators, may each be configured to actuate respective actuator arm assemblies or sets of multi-actuator arms about separate pivots, for example, mounted at different circumferential locations about the disks. In some examples, each of the two actuator arm assemblies may control half of the heads and write to and read from half of the disk surfaces. In some examples, each of the actuator arm assemblies may be addressable by host 44 as a separate logical data storage unit. Other examples may employ more than two actuator arm assemblies or primary actuators or multi-actuators, which may be actuated about a common pivot, or which may be comprised in multiple multi-actuators mounted at different circumferential locations about the disks. Actuator arm assembly 19 and/or any of these other examples may thus constitute and/or comprise an actuator mechanism, in various examples. An actuator mechanism such as actuator arm assembly 19 may thus be configured to position heads 18, including a selected head among one or more heads 18, proximate to a corresponding disk surface 17 among the one or more disks 16.

In executing example method 80 of FIG. 2C (aspects of which will also be further explained below with reference to the further figures), control circuitry 22 may issue one or more commands to other components of disk drive 15, receive information from one or more other components of disk drive 15, and/or perform one or more internal operations, such as generating one or more driver currents for outputting to system components of disk drive 15. In a particular example, read/write circuitry 24 of control circuitry 22 may divide data associated with a write command into multiple data chunks (82). Read/write circuitry 24 may further write respective ones of the multiple data chunks to at least two tracks among the plurality of tracks at locations associated with sequential logical block addresses (LBAs), wherein respective ones of the locations associated with the sequential LBAs alternate between the at least two tracks (84). Read/write circuitry 24 may further, in response to a read command associated with the data, read the multiple data chunks from the at least two tracks by passing the read elements simultaneously over the at least two tracks (86). Control circuitry 22, including read/write circuitry 24, may further perform additional actions, methods, and techniques, in accordance with various aspects including as further described herein.

The term “read/write circuitry 24” as used herein may refer to any hardware, firmware, software, and/or combination thereof, comprised in control circuitry 22 of disk drive 15, which implements, embodies, or engages in any of the structures or functions ascribed herein to read/write circuitry 24 or to any other of the novel and inventive aspects of the present disclosure. Read/write circuitry 24 may constitute any hardware, firmware, software, and/or any other elements of control circuitry 22 for optimizing write performance in disk drives having an unequal number of readers and writers and performing other techniques and methods as described herein.

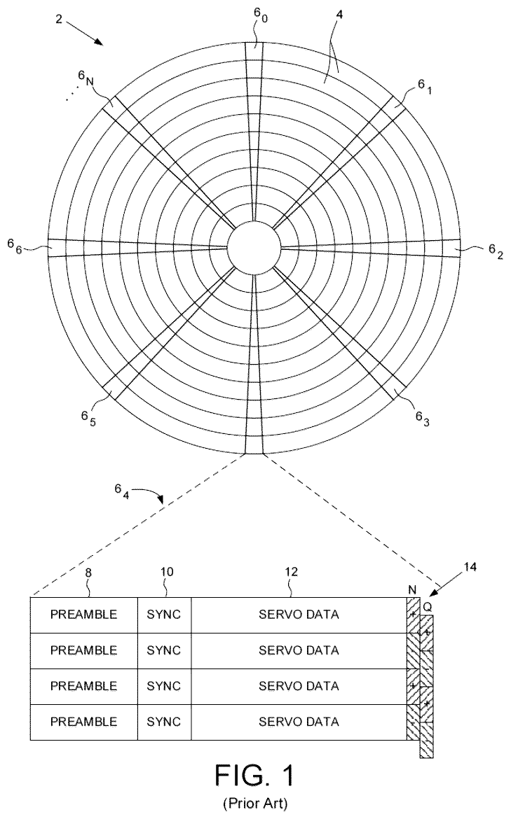

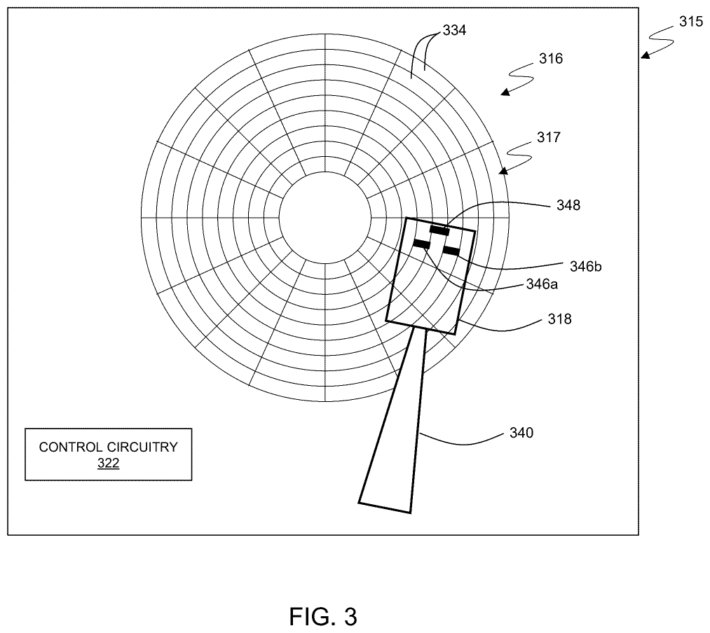

FIG. 3 illustrates a conceptual block diagram of a top view of a head relative to a disk in accordance with various aspects of the present disclosure. In particular, FIG. 3 shows a disk drive 315 including a disk 316 that corresponds to one of disks 16 of FIG. 2B, a head 318 that corresponds to one of heads 18 of FIG. 2B, and control circuitry 322 that corresponds to control circuitry 22 of FIG. 2A. Disk drive 315 may correspond to disk drive 15 of FIG. 2A and may be configured to perform the method of FIG. 2C in accordance with aspects of the present disclosure. Disk surface 317 includes a plurality of concentric tracks 334 each divided into plural data sectors for recording user data. Although not shown, each of the tracks 334 may also include plural servo sectors that contain servo information such as that described with respect to servo wedges 6ᵢ of FIG. 1. In various embodiments, head 318 includes M number of write elements 348 (also called writers), each of which may comprise an inductive write coil, and N number of read elements 346a and 346b (also called readers), each of which may comprise a magnetoresistive (MR) element. Control circuitry 322 may write data to disk surface 317 by modulating a write current in an inductive write coil in write element 348 to record magnetic transitions onto corresponding disk surface 317 in a process referred to as saturation recording. During readback, read elements 346a and 346b sense the magnetic transitions, and a read channel demodulates the resulting read signal. In the example shown in FIG. 3, head 318 is supported over disk surface 317 by actuator arm 340 that may be rotated about a pivot by an actuator (e.g., a VCM) to selectively position head 318 radially over disk 316. Although not shown, head 318 may include other elements, such as a fly height actuator, for example.

In various embodiments, the number of read elements in head 318 is greater than the number of write elements (e.g., N>M). In the example shown in FIG. 3, head 318 includes two read elements 346a and 346b (N=2) and one write element 348 (M=1). In response to a read command received from a host (e.g., host 44 of FIG. 2A), disk drive 315 may read data concurrently from two paired tracks on disk surface 317 by passing the two read elements 346a and 346b simultaneously over the paired tracks, thereby enabling substantially double the read throughput compared to disk drives that read data from only a single track at a time using a single read element. Embodiments are not limited to the example shown in FIG. 3 where N=2 and M=1, and implementations may include other values for M (i.e., number of write elements) and other values for N (i.e., number of read elements), where N is greater than M and where the write element(s) and read elements are in a same head and interact with a same corresponding disk surface.

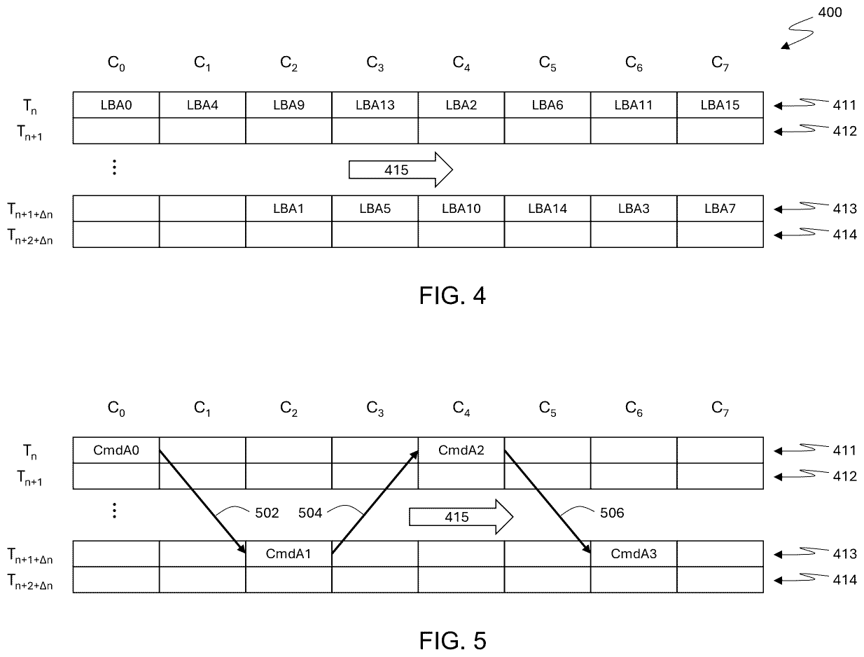

FIG. 4 illustrates a conceptual block diagram of a mapping of portions of tracks on a disk surface to logical block addresses (LBAs) in accordance with various aspects of the present disclosure. In particular, FIG. 4 shows a portion of a logical-physical map 400 in which sequential ones of a plurality of LBAs (e.g., LBA0, LBA1, LBA2, LBA3) are mapped to respective containers defined in a first track 411 and a second track 413 in an alternating manner between the first track 411 and the second track 413 along a down-track direction 415 associated with the first track 411 and the second track 413. Data defining map 400 may be stored in control circuitry 322 and used by control circuitry 322 when writing data to, and reading data from, disk 316. In the example shown in FIG. 4, tracks 411, 412, 413, and 414 correspond to respective ones of tracks 334 on disk surface 317 of disk 316 of FIG. 3. Additional tracks may be present on the disk surface although they are not shown in FIG. 4. In this example, track 411 represents track number Tₙ, track 412 represents track number Tₙ₊₁, track 413 represents track number T_{n+1+Δn}, and track 414 represents track number T_{n+2+Δn}. In this example, tracks 411 and 413 represent a first set of paired tracks that are configured to be read simultaneously using the two read elements 346a and 346b of FIG. 3, and tracks 412 and 414 represent a second set of paired tracks that are configured to be read simultaneously using the two read elements 346a and 346b of FIG. 3. Additional sets of paired tracks that are configured to be read simultaneously may be defined on the disk surface although they are not shown in FIG. 4.

With continued reference to FIG. 4, and in accordance with aspects of the present disclosure, a plurality of logical space containers is defined in each of the tracks 411-414. In the example shown in FIG. 4, each of the tracks 411-414 is divided into logical space containers C₀-C₇ (referred to herein simply as containers). Embodiments are not limited to this number of containers in the tracks, and more or fewer than this number of containers may be defined in the tracks in other implementations. In embodiments, each of the containers C₀-C₇ has a same size that may correspond to the size of one or more data sectors defined by the formatting of the disk drive. In a particular non-limiting example, each of the containers C₀-C₇ is sized to store 64 KB (kilobytes) of data.

In accordance with aspects of the present disclosure, map 400 is configured such that sequential LBAs in respective groups of LBAs are mapped to respective ones of the containers C₀-C₇ in a set of paired tracks in an alternating manner between the paired tracks along a down-track direction associated with the paired tracks. For example, as shown in FIG. 4, a first group of sequential LBAs includes LBA0, LBA1, LBA2, and LBA3 that are mapped to respective ones of the containers C₀-C₇ in paired tracks 411 and 413 in an alternating manner between the paired tracks 411 and 413 along the down track direction 415. In this particular example, LBA0 is mapped to container C₀ in track 411, LBA1 is mapped to container C₂ in track 413, LBA2 is mapped to container C₄ in track 411, and LBA3 is mapped to container C₆ in track 413. In this manner, map 400 alternates the sequential LBAs (LBA0, LBA1, LBA2, LBA3) between the paired tracks 411 and 413 in the down-track direction 415. In the example shown in FIG. 4, map 400 alternates additional groups of sequential LBAs (e.g., LBA4, LBA5, LBA6, LBA7) between tracks 411 and 413 in a similar manner. Embodiments are not limited to this number of sequential LBAs in a group of LBAs, and more or fewer than this number of sequential LBAs may be used in respective groups. Moreover, although the mapping is illustrated for only tracks 411 and 413, it is understood that a similar logic may be used for mapping other LBAs to other containers in other sets of paired tracks on the disk surface.

According to aspects of the present disclosure, when performing a write operation based on a write command (e.g., from host 44), control circuitry 322 divides the data associated with the write command (e.g., the data to be written to the disk surface 317) into multiple data chunks and controls head 318 to write the data chunks to disk locations corresponding to sequential LBAs as defined by a logical-physical map such as map 400. In embodiments, each of the data chunks has a size that is less than or equal to the size of one of the containers C₀-C₇ (64 KB in one example).

FIG. 5 illustrates a conceptual block diagram of writing data chunks to sequential LBAs in an alternating manner between paired tracks in a multi-access disk drive in accordance with various aspects of the present disclosure. Operations associated with FIG. 5 may be performed by control circuitry 322 in disk drive 315 of FIG. 3 using map 400 of FIG. 4. In particular, FIG. 5 shows an example in which data associated with a write command has been divided into data chunks CmdA0, CmdA1, CmdA2, and CmdA3. In this example, control circuitry 322 utilizes map 400 to control head 318 to: write the first data chunk (CmdA0) at a first disk location associated with a first one of the sequential LBAs (e.g., LBA0 at container C₀ of track 411); write the second data chunk (CmdA1) at a second disk location associated with a second one of the sequential LBAs (e.g., LBA1 at container C₂ of track 413); write the third data chunk (CmdA2) at a third disk location associated with a third one of the sequential LBAs (e.g., LBA2 at container C₄ of track 411); and write the fourth data chunk (CmdA3) at a fourth disk location associated with a fourth one of the sequential LBAs (e.g., LBA3 at container C₆ of track 413).

With continued reference to FIG. 5, and in accordance with aspects of the present disclosure, control circuitry 322 moves head 318 back and forth between the paired tracks (tracks 411 and 413 in this example) during a single revolution of the disk 316 when writing the data chunks (CmdA0, CmdA1, CmdA2, and CmdA3 in this example) to the disk locations corresponding to the sequential LBAs (LBA0, LBA1, LBA2, LBA3 in this example). In various embodiments, disk drive 315 comprises a conventional magnetic recording (CMR) disk drive that is capable of writing back and forth between paired tracks in this manner. In accordance with aspects of the present disclosure, in response to a read command to read the same data, control circuitry 322 is configured to position head 318 relative to disk surface 317 such that the two read elements 346a and 346b pass over the paired tracks (tracks 411 and 413 in this example) simultaneously during a single revolution of the disk 316, such that data from the paired tracks is read concurrently by the two read elements. By writing data to the paired tracks in a single revolution of the disk as depicted in FIG. 5, for example, multi-access disk drives according to aspects of the present disclosure enable higher write data rates compared to multi-access disk drives that write data to paired tracks in two successive revolutions of the disk. In this manner, multi-access disk drives according to aspects of the present disclosure provide an improved total data rate by greatly improving the write data rate associated with writing data while also enabling the high read data rate achieved by reading multiple tracks simultaneously.

As is evident from FIGS. 3-5, control circuitry 322 in an example multi-access disk drive in accordance with aspects of the present disclosure may be configured to: divide data associated with a write command into multiple data chunks (e.g., CmdA0, CmdA1, CmdA2, and CmdA3); write respective ones of the multiple data chunks to at least two tracks (e.g., tracks 411 and 413) among a plurality of tracks at locations associated with sequential LBAs (e.g., LBA0, LBA1, LBA2, LBA3), wherein respective ones of the locations associated with the sequential LBAs alternate between the at least two tracks; and, in response to a read command associated with the data, read the multiple data chunks from the at least two tracks by passing the read elements (e.g., read elements 346a and 346b) simultaneously over the at least two tracks. In various embodiments, writing the respective ones of the multiple data chunks comprises moving the head (e.g., head 318) back and forth between the at least two tracks during a single revolution of the disk. In various embodiments, the locations associated with the sequential LBAs comprise containers (e.g., containers C₀-C₇) defined in the first track and the second track, and respective ones of the sequential LBAs are mapped to respective ones of the containers in an alternating manner between the first track and the second track along a down-track direction (e.g., direction 415) associated with the first track and the second track.

Still referring to FIG. 5, and in accordance with aspects of the present disclosure, arrow 502 represents a skew between container C₀ in track 411 and container C₂ in track 413, arrow 504 represents a skew between container C₂ in track 413 and container C₄ in track 411, and arrow 506 represents a skew between container C₄ in track 411 and container C₆ in track 413. In embodiments, the skew corresponds to a distance (e.g., length along a track), measured in the down-track direction 415, between the end of a first container mapped to a first one of the sequential LBAs (e.g., container C₀ mapped to LBA0) and the beginning of a second container mapped to a next one of the sequential LBAs (e.g., container C₂ mapped to LBA1) in a group of sequential LBAs. In embodiments, the skew accounts for a time involved in moving head 318 from a physical location associated with a container in one of the paired tracks to a physical location associated with another container in the other one of the paired tracks, e.g., during a seek operation of head 318 that includes seek time and latency time. In the example shown in FIG. 5, the length of the skew between respective containers mapped to successive ones of the sequential LBAs equals a length of the respective ones of the containers C₀-C₇ (with the lengths being measured in the down-track direction 415). However, the length of the respective ones of the containers C₀-C₇ is not limited to being equal to the length of the skew. Defining containers with a length larger than the length of the skew may be used to enable higher write efficiencies.

In embodiments, the length of the skew may result in one or more containers being between successive ones of data chunks of a write command in a respective track. In the example shown in FIG. 5, the length of the skew equals the length of one of the containers, and this results in three containers being between successive ones of the data chunks in each of the respective tracks. For example, FIG. 5 shows three containers C₁-C₃ between successive data chunks CmdA0 and CmdA2 in first track 411 and three containers C₃-C₅ between successive data chunks CmdA1 and CmdA3 in second track 413. Control circuitry 322 may write data associated with other write commands in these containers, with the result being that data associated with different write commands may be interleaved in the paired tracks.

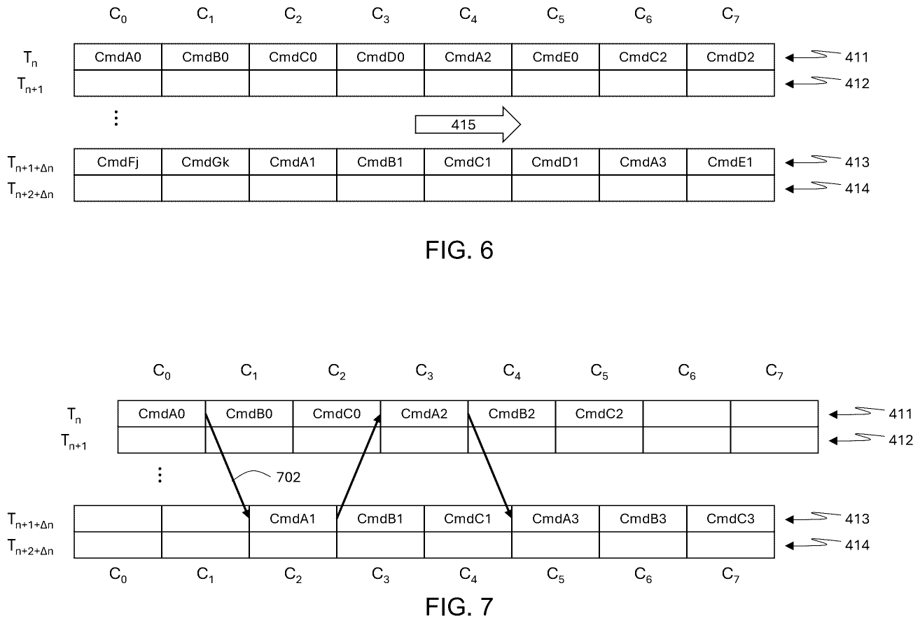

FIG. 6 illustrates a conceptual block diagram of data chunks associated with different write commands written to paired tracks in an alternating manner and interleaved in a multi-access disk drive in accordance with various aspects of the present disclosure. Operations associated with FIG. 6 may be performed by control circuitry 322 in disk drive 315 of FIG. 3 using map 400 of FIG. 4. In particular, FIG. 6 shows an example in which control circuitry 322 divides data associated with a first write command into data chunks CmdA0, CmdA1, CmdA2, and CmdA3 and utilizes map 400 to write the data chunks to respective containers associated with sequential LBAs (e.g., LBA0, LBA1, LBA2, LBA3) in tracks 411 and 413. The example in FIG. 6 further shows how control circuitry 322 divides data associated with a second write command into data chunks CmdB0 and CmdB1 and utilizes map 400 to write the data chunks to respective containers associated with sequential LBAs (e.g., LBA4 and LBA5) in tracks 411 and 413. The example in FIG. 6 additionally shows how control circuitry 322 divides data associated with a third write command into data chunks CmdC0, CmdC1, and CmdC2 and utilizes map 400 to write the data chunks to respective containers associated with sequential LBAs (e.g., LBA9, LBA10, and LBA11) in tracks 411 and 413. The example in FIG. 6 event further shows how control circuitry 322 divides data associated with a fourth write command into data chunks CmdD0, CmdD1, and CmdD2 and utilizes map 400 to write the data chunks to respective containers associated with sequential LBAs (e.g., LBA13, LBA14, and LBA15) in tracks 411 and 413. The example in FIG. 6 still further shows how control circuitry 322 divides data associated with a fifth write command into data chunks CmdE0 and CmdE1 and utilizes map 400 to write the data chunks to respective containers associated with sequential LBAs (e.g., LBA6 and LBA7) in tracks 411 and 413. In this manner, control circuitry 322 is configured to write data chunks associated with a respective write command to sequential LBAs in the paired tracks, while also writing the data chunks for the multiple write commands in an interleaved layout in the paired tracks.

FIG. 7 illustrates a conceptual block diagram of data chunks associated with different write commands written to paired tracks in an alternating manner and interleaved in a multi-access disk drive in accordance with various aspects of the present disclosure. In the example shown in FIG. 7, data associated with three different write commands is interleaved in the paired tracks 411 and 413, and the skew is half the length of one of the containers. In this example, data chunks associated with a first write command (e.g., CmdA0, CmdA1, CmdA2, and CmdA3) are written to sequential LBAs that alternate between the first track 411 and the second track 413, data chunks associated with a second write command (e.g., CmdB0, CmdB1, CmdB2, and CmdB3) are written to other sequential LBAs that alternate between the first track 411 and the second track 413, and data chunks associated with a third write command (e.g., CmdC0 CmdC1, CmdC2, and CmdC3) are written to yet other sequential LBAs that alternate between the first track 411 and the second track 413. In this example, the skew 702 between CmdA0 and CmdA1 is half the length of one of the containers C₀-C₇. This results in two containers C₁-C₂ between successive data chunks CmdA0 and CmdA2 in first track 411 and two containers C₃-C₄ between successive data chunks CmdA1 and CmdA3 in second track 413.

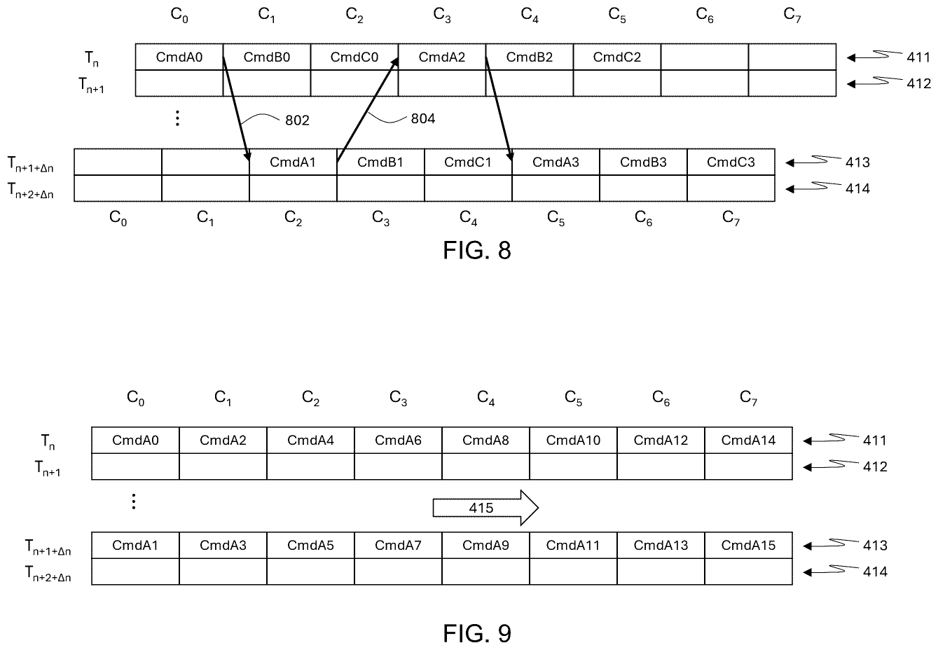

FIG. 8 illustrates a conceptual block diagram of data chunks associated with different write commands written to paired tracks in an alternating manner and interleaved in a multi-access disk drive in accordance with various aspects of the present disclosure. In the example shown in FIG. 8, the same data as shown in FIG. 7 is interleaved in the paired tracks 411 and 413 but with different skew lengths compared to FIG. 7. In the example of FIG. 8, the skew 802 from the first track 411 to the second track 413 has a different length than the skew 804 from the second track 413 to the first track 411. For example, the skew 802 may have a length that is ¼ the length of a container, and the skew 804 may have a length that is ¾ the length of a container. The examples shown in FIGS. 5, 7, and 8 demonstrate that the number of interleaves and the skew length may be configured to achieve desired levels of capacity and performance. As used herein, a number of interleaves refers to the number of different write commands having data chunks that are interleaved in the paired tracks in accordance with aspects of the present disclosure. For example, FIG. 6 shows a number of interleaves equal to four in paired tracks 411 and 413, whereas FIGS. 7 and 8 show a number of interleaves equal to three in paired tracks 411 and 413.

In some embodiments, the number of interleaves equals two, the number of the containers between successive ones of the multiple data chunks in a respective one of the at least two tracks equals zero, and respective gaps that are smaller than the containers are between the successive ones of the multiple data chunks in the respective one of the at least two tracks. In these embodiments, the gaps may be used for other types of data or may be sacrificed capacity.

FIG. 9 illustrates a conceptual block diagram of writing data chunks associated with a large write command to sequential LBAs in an alternating manner between paired tracks in a multi-access disk drive in accordance with various aspects of the present disclosure. Operations associated with FIG. 9 may be performed by control circuitry 322 in disk drive 315 of FIG. 3 using a map similar to map 400 of FIG. 4. As used herein, and as shown in the example in FIG. 9, a large write command includes data that fills at least two full tracks (e.g., tracks 411 and 413) in disk 316. In various embodiments, control circuitry 322 divides the data of the large write command into data chunks (e.g., CmdA0, CmdA1, . . . , CmdA15) and writes the reordered data chunks to the paired tracks (e.g., tracks 411 and 413) directly without the head moving back and forth between the tracks. In this example, control circuitry 322 writes data chunks CmdA0, CmdA2, . . . , CmdA14 to track 411 during a first revolution and writes data chunks CmdA1, CmdA3, . . . , CmdA15 to track 413 during a second revolution.

As described herein, multi-access disk drives in accordance with aspects of the present disclosure may have N number of read elements and M number of write elements and may use novel and inventive methods for minimizing costs and maximizing benefits of increased throughput. For larger transfer lengths, embodiments enable an N-times increase in the read workload at a same number of IOPS (input/output operations per second) when increasing transfer length by a factor of N compared to disk drives that use a single reader to read data. Expression 1 may be used to determine an amount of throughput increase provided by embodiments.

throughput increase=(r+w)/((r/n)+(w/m)) (expression 1)

In Expression 1, r represents a proportion of the workload associated with reads, w represents a proportion of the workload associated with writes, n represents a number of read elements, and m represents a number of write elements. In an example using two read elements (n=2), one write element (m=1), fifty percent reads (r=0.5), and fifty percent writes (w=0.5), Expression 1 indicates that embodiments enable a 1.33× increase (33% increase) in overall throughput (e.g., IOPS and mebibytes per second (MiB/s)) compared to disk drives that use a single reader to read data.

Any suitable control circuitry may be employed to implement the flow diagrams in the above examples, such as any suitable integrated circuit or circuits. For example, the control circuitry may be implemented within a read channel integrated circuit, or in a component separate from the read channel, such as a data storage controller, or certain operations described above may be performed by a read channel and others by a data storage controller. In some examples, the read channel and data storage controller may be implemented as separate integrated circuits, and in some examples, the read channel and data storage controller may be fabricated into a single integrated circuit or system on a chip (SoC). In some examples, the control circuitry may include a suitable preamp circuit implemented as a separate integrated circuit, integrated into the read channel or data storage controller circuit, or integrated into an SoC.

In some examples, the control circuitry may comprise a microprocessor executing instructions, the instructions being operable to cause the microprocessor to perform one or more aspects of methods, processes, or techniques shown in the flow diagrams and described with reference thereto herein. Executable instructions of this disclosure may be stored in any computer-readable medium. In some examples, executable instructions of this disclosure may be stored on a non-volatile semiconductor memory device, component, or system external to a microprocessor, or integrated with a microprocessor in an SoC. In some examples, executable instructions of this disclosure may be stored on one or more disks and read into a volatile semiconductor memory when the disk drive is powered on. In some examples, the control circuitry may comprise logic circuitry, such as state machine circuitry. In some examples, at least some of the flow diagram blocks may be implemented using analog circuitry (analog comparators, timers, etc.). In some examples, at least some of the flow diagram blocks may be implemented using digital circuitry or a combination of analog and digital circuitry.

In various examples, one or more processing devices may comprise or constitute the control circuitry as described herein and/or may perform one or more of the functions of control circuitry as described herein. In various examples, the control circuitry, or other one or more processing devices performing one or more of the functions of control circuitry as described herein, may be abstracted away from being physically proximate to the disks and disk surfaces. The control circuitry, and/or one or more device drivers thereof, and/or one or more processing devices of any other type performing one or more of the functions of control circuitry as described herein, may be part of or proximate to a rack of multiple data storage devices, or a unitary product comprising multiple data storage devices, or may be part of or proximate to one or more physical or virtual servers, or may be part of or proximate to one or more local area networks or one or more storage area networks, or may be part of or proximate to a data center, or may be hosted in one or more cloud services, in various examples.

In various examples, a disk drive may include a magnetic disk drive, an optical disk drive, a hybrid disk drive, or other types of disk drive. Some examples may include electronic devices such as computing devices, data server devices, media content storage devices, or other devices, components, or systems that may comprise the storage media and/or control circuitry as described above.

The various features and processes described above may be used independently of one another or may be combined in various ways. All possible combinations and subcombinations fall within the scope of this disclosure. Certain method, event, or process blocks may be omitted in some implementations. The methods and processes described herein are not limited to any particular sequence, and the blocks or states relating thereto can be performed in other sequences. For example, described tasks or events may be performed in an order other than that specifically disclosed, or multiple may be combined in a single block or state. The example tasks or events may be performed in serial, in parallel, or in another manner. Tasks or events may be added to or removed from the disclosed examples. The example systems and components described herein may be configured differently than described. For example, elements may be added to, removed from, or rearranged compared to the disclosed examples.

While certain example embodiments are described herein, these embodiments are presented by way of example only and do not limit the scope of the inventions disclosed herein. Thus, nothing in the foregoing description implies that any particular feature, characteristic, step, module, or block is necessary or indispensable.

The novel methods and systems described herein may be embodied in a variety of other forms. Various omissions, substitutions, and changes in the form of the methods and systems described herein may be made without departing from the spirit and scope of the present disclosure.

Method 80 and other methods of this disclosure may include other steps or variations in various other embodiments. Some or all of any of method 80 and other methods of this disclosure may be performed by or embodied in hardware and/or performed or executed by a controller, a central processing unit (CPU), a field-programmable gate array (FPGA), an SoC, a multi-processor system on chip (MPSoC), which may include both a CPU and an FPGA, and other elements together in one integrated SoC, or other processing device or computing device processing executable instructions, in controlling other associated hardware, devices, systems, or products in executing, implementing, or embodying various subject matter of the method. Steps of method 80, and other methods of this disclosure, may be performed individually or in combination by one or more processing devices. For example, in some implementations, the one or more processing devices may comprise a single processing device that performs all the steps of such a method. In some implementations, different respective ones of the one or more processing devices may perform different respective steps of such a method. For example, in some implementations, the one or more processing devices may comprise at least a first processing device that performs a first subset of the steps of such a method and at least a second processing device that performs a second subset of the steps of the method. In some implementations, one or more steps of such a method may be performed by two or more of the one or more processing devices acting in combination.

Data storage systems, devices, and methods implemented with and embodying novel advantages of the present disclosure are thus shown and described herein, in various foundational aspects and in various selected illustrative applications, architectures, techniques, and methods for implementing and embodying novel advantages of the present disclosure. Persons skilled in the relevant fields of art will be well-equipped by this disclosure with an understanding and an informed reduction to practice of a wide panoply of further applications, architectures, techniques, and methods for novel advantages, techniques, methods, processes, devices, and systems encompassed by the present disclosure and by the claims set forth below.

As used herein, the recitation of “at least one of A, B, and C” is intended to mean “either A, B, C, or any combination of A, B, and C.” The descriptions of the disclosed examples are provided to enable any person skilled in the relevant fields of art to understand how to make or use the subject matter of the present disclosure. Various modifications to these embodiments will be readily apparent to those skilled in the art based on the present disclosure, and the generic principles defined herein may be applied to other examples without departing from the spirit or scope of the disclosure. Thus, the present disclosure is not limited to the embodiments shown herein but is to be accorded the widest scope consistent with the principles and novel features disclosed herein.

The present disclosure and many of its attendant advantages will be understood by the foregoing description, and various changes may be made in the form, construction, and arrangement of the components without departing from the disclosed subject matter or without sacrificing all or any of its material advantages. The form described is merely explanatory, and the following claims encompass and include a wide range of embodiments, including a wide range of examples encompassing any such changes in the form, construction, and arrangement of the components as described herein.

While the present disclosure has been described with reference to various examples, it will be understood that these examples are illustrative and that the scope of the disclosure is not limited to them. All subject matter described herein are presented in the form of illustrative, non-limiting examples, and not as exclusive implementations, whether or not they are explicitly called out as examples as described. Many variations, modifications, and additions are possible within the scope of the examples of the disclosure. More generally, examples in accordance with the present disclosure have been described in the context of particular implementations. Functionality may be separated or combined in blocks differently in various examples of the disclosure or described with different terminology, without departing from the spirit and scope of the present disclosure and the following claims. These and other variations, modifications, additions, and improvements may fall within the scope of the disclosure as defined in the claims that follow.

1. A data storage device, comprising:
a disk having a disk surface that includes a plurality of tracks;
a head configured to be positioned proximate to the disk surface and including N number of read elements and M number of write elements, wherein N is greater than M; and
one or more processing devices, individually or in combination, configured to:
divide data associated with a write command into multiple data chunks;
write respective ones of the multiple data chunks to at least two tracks among the plurality of tracks at locations associated with sequential logical block addresses (LBAs), wherein respective ones of the locations associated with the sequential LBAs alternate between the at least two tracks; and
in response to a read command associated with the data, read the multiple data chunks from the at least two tracks by passing the read elements simultaneously over the at least two tracks.

2. The data storage device of claim 1, wherein the respective ones of the locations associated with the sequential LBAs alternate back and forth between the at least two tracks along a down-track direction associated with the at least two tracks.

3. The data storage device of claim 1, wherein the writing the respective ones of the multiple data chunks comprises moving the head back and forth between the at least two tracks during a single revolution of the disk.

4. The data storage device of claim 1, wherein:
N equals two; and
M equals one.

5. The data storage device of claim 1, wherein the at least two tracks comprise a first track and a second track.

6. The data storage device of claim 5, wherein the locations comprise containers defined in the first track and containers defined in the second track.

7. The data storage device of claim 6, wherein respective ones of the sequential LBAs are mapped to respective ones of the containers in an alternating manner between the first track and the second track along a down-track direction associated with the first track and the second track.

8. The data storage device of claim 6, wherein the one or more processing devices, individually or in combination, are further configured to interleave the data associated with a write command with other data associated with one or more other write commands in the first track and the second track.

9. The data storage device of claim 8, wherein:
a number of interleaves equals four, wherein the number of interleaves equals a number of different write commands having data chunks that are interleaved in the first track and the second track; and
a number of the containers between successive ones of the multiple data chunks in a respective one of the at least two tracks equals three.

10. The data storage device of claim 8, wherein:
a number of interleaves equals three, wherein the number of interleaves equals a number of different write commands having data chunks that are interleaved in the first track and the second track; and
a number of the containers between successive ones of the multiple data chunks in a respective one of the at least two tracks equals two.

11. The data storage device of claim 1, wherein the data storage device comprises a conventional magnetic recording (CMR) disk drive.

12. A method comprising:
dividing data associated with a write command into multiple data chunks;
writing respective ones of the multiple data chunks to at least two tracks among a plurality of tracks at locations associated with sequential logical block addresses (LBAs), wherein the plurality of tracks is on a disk surface associated with a disk in a disk drive, wherein respective ones of the locations associated with the sequential LBAs alternate between the at least two tracks, and wherein the writing the respective ones of the multiple data chunks further comprises moving, by the one or more processing devices individually or in combination, the head back and forth between the at least two tracks during a single revolution of the disk; and
in response to a read command associated with the data, reading the multiple data chunks from the at least two tracks by passing read elements simultaneously over the at least two tracks,
wherein the dividing, the writing, and the reading are performed by one or more processing devices individually or in combination.

13. The method of claim 12, wherein the disk drive comprises a conventional magnetic recording (CMR) disk drive.

14. The method of claim 12, wherein:
the writing is performed, by the one or more processing devices individually or in combination, using M number of write elements in a head that is configured to be positioned proximate to the disk surface;
the reading is performed, by the one or more processing devices individually or in combination, using N number of the read elements in the head; and
N is greater than M.

15. The method of claim 12, wherein the respective ones of the locations associated with consecutive ones of the sequential LBAs alternate back and forth between the at least two tracks along a down-track direction associated with the at least two tracks.

16. (canceled)

17. One or more processing devices, individually or in combination, comprising:
means for dividing data associated with a write command into multiple data chunks;
means for writing respective ones of the multiple data chunks to at least two tracks among a plurality of tracks at locations associated with sequential logical block addresses (LBAs), wherein the plurality of tracks is on a disk surface associated with a disk in a disk drive, and wherein respective ones of the locations associated with consecutive ones of the sequential LBAs alternate back and forth between the at least two tracks; and
means for reading the multiple data chunks from the at least two tracks by passing read elements simultaneously over the at least two tracks in response to a read command associated with the data.

18. The one or more processing devices of claim 17, wherein:
the writing is performed, by the one or more processing devices individually or in combination, using M number of write elements in a head that is configured to be positioned proximate to the disk surface;
the reading is performed, by the one or more processing devices individually or in combination, using N number of the read elements in the head; and
N is greater than M.

19. (canceled)

20. The one or more processing devices of claim 17, wherein the one or more processing devices, individually or in combination, further comprise means for moving the head back and forth between the at least two tracks during a single revolution of the disk during the writing.

21. The data storage device of claim 1, wherein:
the at least two tracks comprise a first track and a second track; and
the writing the respective ones of the multiple data chunks comprises:
writing a first one of the multiple data chunks at a first location in the first track;
moving the head from the first location in the first track to a second location in the second track and writing a second one of the multiple data chunks at the second location in the second track; and
moving the head from the second location in the second track to a third location in the first track and writing a third one of the multiple data chunks at the third location in the first track, wherein the writing the first one of the multiple data chunks, the writing the second one of the multiple data chunks, and the writing the third one of the multiple data chunks are performed during a single revolution of the disk.

22. The data storage device of claim 21, wherein:
the first location in the first track precedes the second location in the second track in a down-track direction; and
the second location in the second track precedes the third location in the first track in the down-track direction.
